(19) United States
(12) Patent Application Publication
(10) Pub. No.: US 2008/0206729 A1
(43) Pub. Date: Aug. 28, 2008

(54) Apparatus for managing a child's time

(75) Inventors: Karolyn Woolverton, Fayetteville, AR (US); Frederick Woolverton, Fayetteville, AR (US); Joanna Ferrone, Southampton, NY (US)

Correspondence Address: KAROLYN AND FREDERICK WOOLVERTON, ONE WEST MOUNTAIN STREET, FAYETTEVILLE, AR, 72701, US

(73) Assignee: Timeframe, LLC

(21) Appl. No.: 11/709,636

(22) Filed: Feb. 22, 2007

(51) Int. Cl. G04F 1/00; G09B 19/00

(52) U.S. Cl. 434/304; 368/107; 368/45

(57) ABSTRACT

A timer and a watch for managing the behavior of children are disclosed. The timer and watch both utilize linear movement to depict the passage of time, which relates a child's instinctive understanding of speed and distance of linear movement to the passage of time.

### CROSS REFERENCES

None.

### GOVERNMENTAL RIGHTS

None.

### BACKGROUND OF THE INVENTION

Every parent must go through the frustrating task of managing a child's time in a manner that is comprehensible to the child. What makes this process frustrating is the fact that adults and children operate according to entirely different concepts of time. While time has objective properties for adults, the passage of time is a subjective experience for children and depends on what a child is thinking, feeling, and doing during any given period. These subjective factors complicate the already confusing nature of the concept of time in young children.

One typical method parents employ to discipline a child involves removing a child from a given situation and placing the child in “time out.” The parent may exclaim, “Sit in the corner for fifteen minutes,” followed by “Your fifteen minutes is up.” Such a method gives the child no meaningful reference to familiar, child-friendly constructs during the passage of time so that the child can determine at any point how much time has passed and how much time remains. It is an object of the present invention to provide a convenient model that gives a reference point for children to comprehend the amount of time remaining in a given time construct.

Another time-management method utilized by parents involves giving the child a watch so that they can observe the sweep of the watch hands. However, this method does not work for young children, as typically before this age children are unable to comprehend radial motion. It is an object of the present invention to provide an apparatus that depicts the passage of time using concepts of motion that a child can understand.

Devices in the prior art have attempted to teach children the concept of time using specialized timepieces. For instance, U.S. Pat. No. 5,044,961 (the “'961 patent”) discloses an otherwise normal clock that has two additional rotable pieces. The first rotable piece is a spring-wound timer; to activate the timer, the user rotates the timer handle until the desired amount of time is displayed in a first small window of the clock face. As the timer counts down, the timer reflects the passage of time by decrementing the numbers visible through the first small window. The second rotable piece allows a fixed image (such as a toy for play time) to be displayed in a second small window of the clock face. The '961 patent is a deficient time-management tool for parents because very young children are often unable to count. Further, even for those children able to count, the numbers mean nothing to the children with respect to the concept of elapsing time.

French Patent No. 94 12665 (the “French patent”) discloses an apparatus designed to function as a time tracking device. The device utilizes linear movement of an index across a fixed frame over a pre-set amount of time. The user of the French patent fastens icons to the fixed frame to remind the user of specified events occurring during the passage of time. For example, the French patent discloses the use of the device as a calendar with the icons representing various to-do tasks, as an advertisement support tool with the icons representing product design and sale, or as an educational tool used to teach children the concept of time where the icons represent events in the life of a child.

The drawback to the French patent is that a child must be able to know and comprehend the value of time between each given event represented by the various icons. The inventors understand that children of a young age are developmentally incapable of learning the true concept of time or elapsed or remaining time, and any attempts to teach such concepts only result in confusion of the child. Rather, an adult should manage a child's time in a child-centric manner. It is thus an object of the present invention to provide a highly-interactive, adult-managed, child-centric behavioral management tool that visually depicts for a child the continuous elapse of a predetermined amount of time.

The apparatus in accordance with the present invention provides a behavioral management apparatus depicting the passage of time that a child can understand because the apparatus provides a linear reference point that indicates the continual passage of time, thereby inferring the concepts of elapsed and remaining time.

### BRIEF SUMMARY OF THE INVENTION

The present invention frames time for children in a child-friendly manner. Conceptually, the invention recognizes that children do not view time from an adult perspective and cannot understand radial motion, and thus conventional timepieces are incomprehensible abstractions to children. The inventors recognize that children grasp the concept of speed and distance in a linear plane (“how fast” and “how far”) long before they understand duration (“how long”). Accordingly, the present invention measures and presents “how long” as a function of speed (“how fast”) and distance (“how far”) traveled across a substantially linear axis.

The invention comprises an apparatus that depicts the passage of time in a linear manner, as opposed to the radial motion of watches of the prior art. There are three preferred embodiments of the present invention. The first preferred embodiment is a timer that linearly displays the passage of discrete, predetermined amounts of time. The second preferred embodiment is a child's watch that linearly displays the passage of seconds, minutes, and hours to reinforce the conventional numerical depiction of time. The third preferred embodiment is also a child's watch that works in a similar fashion to the first preferred embodiment.

Optionally, the embodiments of the present invention are brightly colored and contain other features designed to attract and maintain a child's attention, such as pictures or sounds. In an optional arrangement of the first preferred embodiment, the marker is an image of a puppy and the tick marks are bowls of dog food. As time passes, the puppy moves from bowl to bowl, eating the food in each bowl before moving to the adjacent bowl. Audio cues can also be used to further relate the passage of time to a child and maintain a child's attention.

These and other advantages will become apparent from the following detailed description which, when viewed in light of the accompanying drawings, disclose the embodiments of the present invention.

### BRIEF DESCRIPTION OF THE DRAWINGS

FIG. 1 is a perspective view of the first preferred embodiment.

FIG. 2 is a top view of the first preferred embodiment.

FIG. 3 is a front view of the first preferred embodiment.

FIG. 4 is a perspective view of the first preferred embodiment when the apparatus is in use.

FIG. 5 is a front view of the second preferred embodiment.

FIG. 6 is a front view of the third preferred embodiment.

FIG. 7 is a perspective view of the fourth preferred embodiment.

FIG. 8 is a front view of the fourth preferred embodiment.

### DETAILED DESCRIPTION OF THE INVENTION

The most desirable way to communicate a new idea to a child is to present the new idea along with an idea the child already understands. Recent studies have shown that even very young children understand the concept of speed and duration in linear movement. The present invention capitalizes on this instinctive understanding of linear movement by depicting the passage of time in a linear fashion.

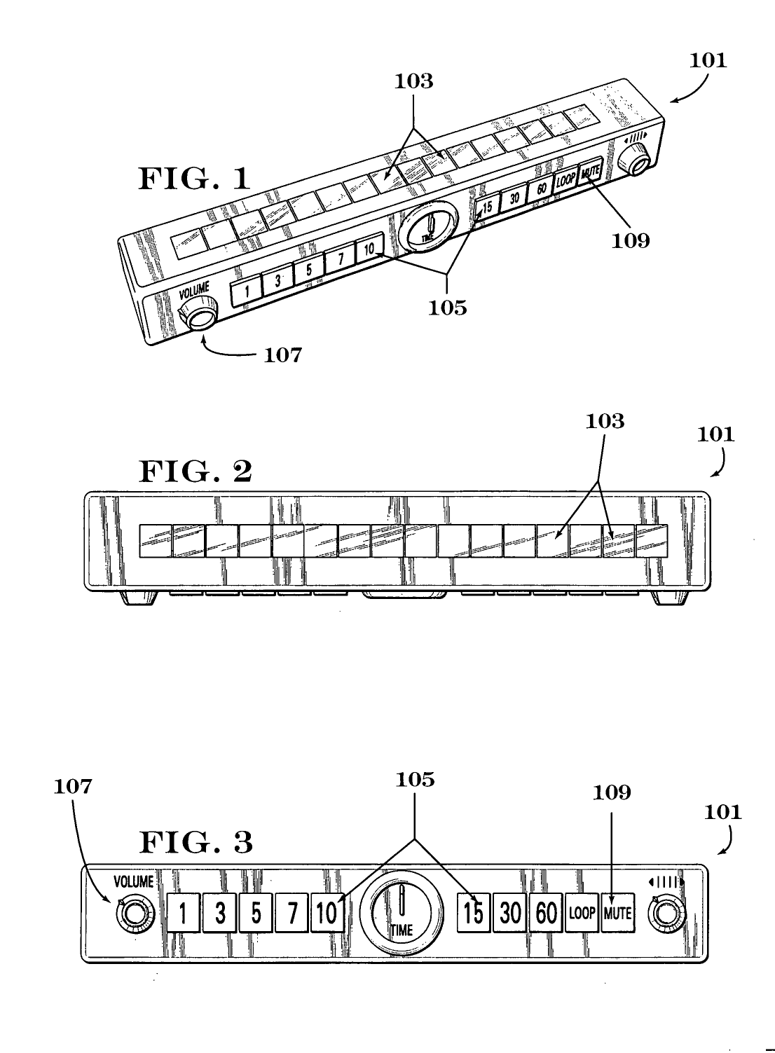

Referring now to FIGS. 1-3, the first preferred embodiment of the behavioral management apparatus 101 has a plurality of markers 103 on a first long side of a rectangular prism. A second long side of behavioral management apparatus 101 has a plurality of buttons 105 for selecting a predetermined amount of time, such as one minute, five minutes, ten minutes, fifteen minutes, thirty minutes, and sixty minutes. When one of the buttons 105 is depressed, marker 103 denotes position along the first long side of behavioral management apparatus 101. The position of marker 103 moves lengthwise along the first long side of behavioral management apparatus 101 to correspond to the time indicated by the depressed button 105. Preferably, the mechanism moving the marker utilizes a microchip to sense and highlight which of buttons 105 was depressed by the operator. Also in the first preferred embodiment, markers 103 are illuminated by light-emitting diodes (LEDs), which light up in consecutive sequence to visually indicate a position along the first long side of behavioral management apparatus 101. However, the present invention is not limited to this embodiment and contemplates the use of mechanical devices, electrical devices, liquid-crystal displays (LCDs), and other such means for visually tracking the marker 103 across the first long side of the prism.

Optionally, the first preferred embodiment of the present invention has volume means 107 for announcing the passage of increments of the total predetermined amount of time. For example, the apparatus may announce the passage of fifteen, thirty, and forty-five minutes out of a sixty-minute period. At the end of the predetermined time period, the apparatus may also announce the end of such period. These sound features may be muted using muting means 109 or by decreasing volume means 107.

The first preferred embodiment is also intended to be used in places where children are likely to ask how long a particular period of time will take to pass. For instance, the first preferred embodiment may be strapped to the back of a vehicle driver's seat to provide an answer to the inevitable refrain of, “when will we get there?” The first preferred embodiment can also be used as a non-threatening tool to enforce a disciplinary “time-out.”

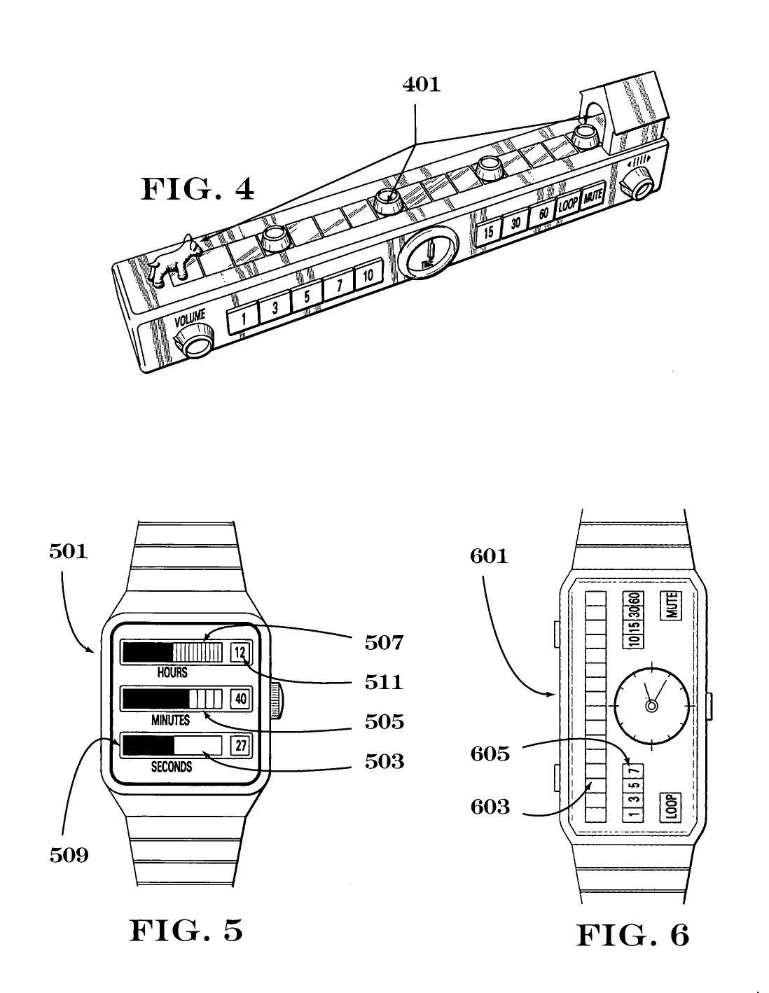

Referring now to FIG. 4, the preferred arrangement of the first preferred embodiment utilizes marker 401 designed to capture the attention of a child.

Referring now to FIG. 5, the second preferred embodiment of the present invention is a watch 501 designed to be worn by children. Watch 501 has three linear elements: seconds element 503, minutes element 505, and hours element 507. Each element has a marker 509 denoting the fraction of the time period that has elapsed. For instance, second marker 509 visually tracks across second element 503 every sixty seconds. Optionally, these three linear elements are reinforced by a depiction 511 of the appropriate component of conventional numerical time adjacent to the appropriate linear element.

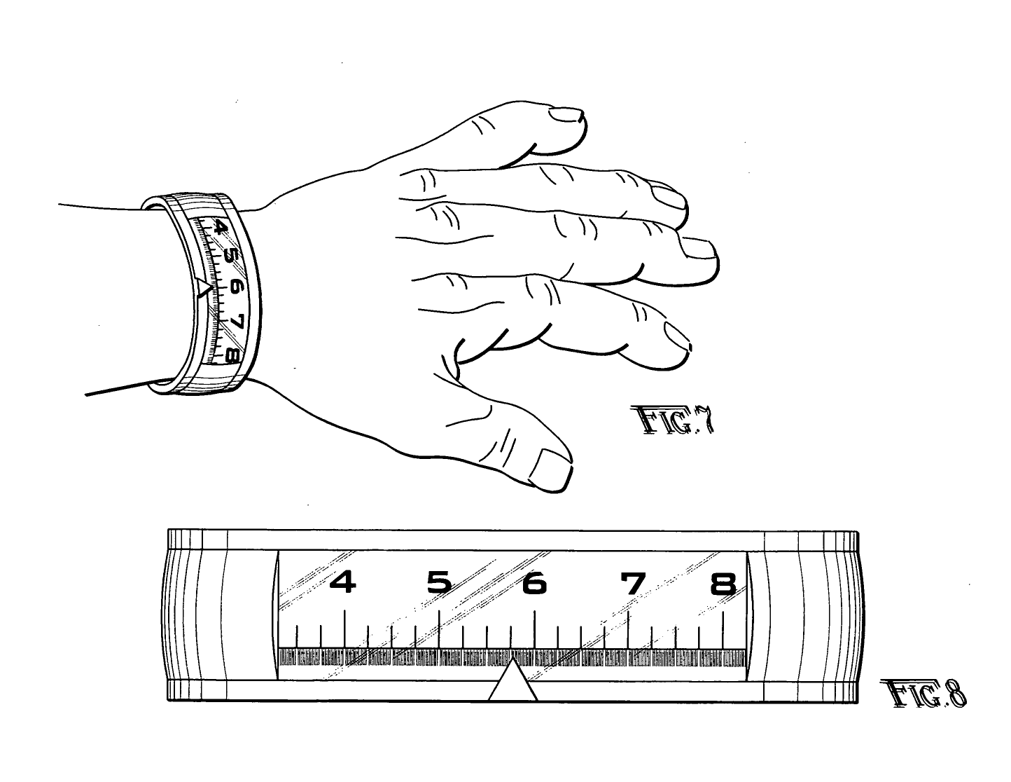

Referring now to FIG. 6, the third preferred embodiment is a type of watch 601 that contains markers 603 and buttons 605 in a manner similar to the first preferred embodiment but contains the added feature of being wearable.

Referring now to FIGS. 7-8, the fourth preferred embodiment is a type of watch that contains markers similar to the first preferred embodiment but contains the added feature of being wearable.

In accordance with the present invention, an adult can easily manage the behavior of a child by using visual tracking of linear movement that the child instinctively understands. However, it should be clear that the present invention is not to be construed as limited to the forms shown, which are to be considered illustrative rather than restrictive.

I claim:

1. An apparatus for managing behavior, comprising:
a plurality of visual markers that visually denote elapsed time along a substantially linear axis;
an input means for allowing a user to select a predetermined amount of time; and
a processing module to activate the visual markers so as to progressively and visually denote the amount of time elapsed and remaining with respect to the predetermined amount of time selected by the user.

2. The apparatus of claim 1, further comprising means for the visual or auditory announcement of the passage of an increment of the predetermined amount of time.

3. The apparatus of claim 1 wherein the markers further comprise images evocative of the length of the predetermined amount of time.

4. The apparatus of claim 1 wherein the apparatus is designed to be worn on the user's body.

5. A watch, comprising a plurality of visual markers that visually denote the elapsed portion of a numerical component of time along a substantially linear axis.

6. The watch of claim 5, further comprising the depiction of the numerical component of time adjacent to the visual markers corresponding to such numerical component.

7. The watch of claim 5, further comprising means for the visual or auditory announcement of the passage of an increment of the predetermined amount of time.
